(19) United States
(12) Patent Application Publication
(10) Pub. No.: US 2003/0163761 A1
(43) Pub. Date: Aug. 28, 2003

(54) System and method for message driven bean service migration

(76) Inventors: Michael Chen, Santa Clara, CA (US); Reto Kramer, San Francisco, CA (US)

Correspondence Address: Sheldon R. Meyer, FLIESLER DUBB MEYER & LOVEJOY LLP, Four Embarcadero Center, Fourth Floor, San Francisco, CA, 94111-4156, US

(21) Appl. No.: 10/371,147

(22) Filed: Feb. 20, 2003

Related U.S. Application Data
(60) Provisional application No. 60/358,749, filed on Feb. 21, 2002.

(51) Int. Cl. G06F 15/16

(52) U.S. Cl. 714/10; 709/203

(57) ABSTRACT

A system and method for migrating services in a Java server environment, and particularly to a mechanism for migrating message driven beans. In accordance with the present invention, the JMS server and MDB's are designed to be migratable from one application server to another. In order to expedite Message Driven Bean (MDB) recovery in a cluster environment before a failed server restarts, the MDB is implemented as a migratable service. This enables the migratable service framework to migrate the MDB and JMS server to another available server in the same cluster. After migration, MDB obtains ownership of the JMS server, and continues to pull the messages from the JMS server on behalf of the failed server. This allows the backup server to read the message from JMS server and continue the service.

### CLAIM OF PRIORITY

This application claims priority from provisional application “SYSTEM AND METHOD FOR MESSAGE DRIVEN BEAN SERVICE MIGRATION” Application No. 60/358,749 filed Feb. 21, 2002, and which application is incorporated herein by reference.

### CROSS-REFERENCES

This application is related to co-pending applications United States Provisional Patent Application entitled EXACTLY ONCE CACHE FRAMEWORK, Inventors Dean Bernard Jacobs and Eric M. Halpern, Application No. 60/317,718, filed Sep. 6, 2001, United States Utility Patent Application entitled EXACTLY ONCE CACHE FRAMEWORK, Inventors Dean Bernard Jacobs and Eric M. Halpern, Application No. 10/234,693, filed Sep. 4, 2002, United States Provisional Patent Application entitled EXACTLY ONCE JMS COMMUNICATION, Inventors Dean Bernard Jacobs and Eric M. Halpern, Application No. 60/317,566, filed Sep. 6, 2001, United States Utility Patent Application entitled EXACTLY ONCE JMS COMMUNICATION, Inventors Dean Bernard Jacobs and Eric M. Halpern, Application No. 10/234,597, filed Sep. 4, 2002, United States Provisional Patent Application entitled SYSTEM AND METHOD FOR MIGRATABLE SERVICES Inventor Eric M. Halpern, Application No. 60/358,418, filed Feb. 21, 2002, United States Utility Patent Application entitled SYSTEMS AND METHODS FOR MIGRATABLE SERVICES Inventor Eric M. Halpern, Application No. ______, filed Feb. 13, 2003, United States Provisional Patent Application entitled SYSTEM AND METHOD FOR AUTOMATED SERVICE MIGRATION Inventor Eric M. Halpern, Application No. 60/358,662, filed Feb. 21, 2002, and United States Utility Patent Application entitled SYSTEMS AND METHODS FOR AUTOMATED SERVICE MIGRATION Inventor Eric M. Halpern, Application No. ______, filed Feb. 13, 2003, all of which applications are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to a system and method for migrating services and message driven beans in a Java server environment.

### BACKGROUND

An ever-increasing number of e-commerce providers or e-businesses rely on application server technology as the lifeblood of their business. Application servers form a proven foundation for developing and supporting e-commerce applications, providing the presentation, business and information-access logic, security and management services, and the underlying infrastructure required for running highly scalable and mission-critical software applications. Increasingly, the demands of today's modern businesses require support for a new breed of Web and wireless applications, helping to meet the needs of increasingly sophisticated customers.

One such application server, WebLogic Server, from BEA Systems, Inc. San Jose, Calif., is based on an implementation of the Java 2 Enterprise Edition (J2EE) specification. WebLogic Server is used as the backbone for many of today's most sophisticated e-business applications, and plays an integral role in a tightly integrated, comprehensive infrastructure that delivers commerce, personalization, campaign management, enterprise integration, workflow management, and business-to-business collaboration. WebLogic Server manages all of the underlying complexities of a business' e-commerce applications, allows the organization to focus instead on delivering new and innovative products and services.

A typical application server, including WebLogic Server, supports a variety of clients, including Web browsers, and wireless devices. On the server side, WebLogic Server supports a variety of operating systems. On the back-end, WebLogic Server integrates with relational databases, messages queues, and legacy systems. WebLogic Server also provides support for features such as Servlets, Java Server Pages (JSPs), Enterprise JavaBeans (EJBs), and Java Messaging Service (JMS), to provide access to standard network protocols, database, and messaging systems. When developing applications, developers can create, assemble, and deploy components that use these services. To allow communication between each of these entities, application servers typically allow applications to pass messages to each other. Messages are events that contain information needed to coordinate communication between different applications. A message thus provides a level of abstraction, allowing the software developer to separate out the details about the destination system from the application, and concentrate on developing the application code itself.

The EJB architecture used by such application servers encourages portability and reuse of application code. In accordance with the industry-standard EJB specification, enterprise bean instances are created and managed at application run time by an EJB container. An EJB container is an entity that provides lifecycle management, security deployment and run time services to EJB components. The EJB container may also provide component-specific or EJB-specific services. When an enterprise bean uses only those standard services defined in the EJB specification, the bean can be deployed within any compliant EJB container. However, some specialized containers can be used to provide additional services beyond those defined by the specification.

Besides its actual implementation, the behavior of the EJB can also be defined during deployment. EJB's are deployed using a deployment descriptor, typically a computer-readable file or group of files that specifies deployment assembly information and settings. By modifying the entries within this deployment descriptor the behavior of the EJB can be customized. This flexibility makes it easy to include an EJB within an application at a later point in time without having to make any changes to the application source code.

The Java Message Service (JMS) is a standard API for accessing enterprise messaging systems. Specifically, JMS enables Java applications to share a messaging system and to exchange messages, and simplifies Java application development by providing a standard interface for creating, sending, and receiving messages. Typically, JMS accepts messages from producer applications and delivers them to consumer applications. The JMS architecture found in Weblogic supports clustering of multiple JMS servers and allows transparent access to destinations from any server in the cluster. The advantages of clustering include: Load balancing of destinations across multiple servers in the cluster; Cluster-wide, transparent access; Distribution of application load across multiple JMS servers; and Optional multicast support, reducing the number of messages required to be delivered by a JMS server.

Within this JMS framework a Message-Driven Bean (MDB) is a special type of EJB that acts as a message consumer within the JMS messaging system. An MDB is a stateless, server-side, transaction-aware component (i.e. it has short-lived instances and does not retain state for a client) that, as the name suggests, is driven by a Java message. The MDB listens to the stream of messages passing to the JMS server and is invoked by the EJB Container when a message is received from a JMS Queue. A Java client, an enterprise bean, a Java ServerPages™ (JSP) component, or a non-J2EE application may send the message. From the client's perspective, the client application interacts with the MDB in the same way it interacts with a regular JMS application or JMS server.

The dynamic creation and allocation of MDB instances mimics the behavior of stateless session EJB instances. However, message-driven beans are different from stateless session EJBs (and other types of EJBs) in that MDBs process multiple JMS messages asynchronously, rather than processing a serialized sequence of method calls, and they cannot be directly accessed by internal or external clients. Clients interact with MDBs only indirectly, by sending a message to a JMS Queue, and having that message passed along to the MDB.

While Message Driven Beans constitute an important part of the overall JMS framework, currently there is no recovery mechanism for failing over a JMS server and it's associated Message Driven Beans. When a server fails, the recovery of the JMS server and it's MDBs typically cannot be performed until the failed server is restarted. Client transactions that were taking place on that server using those MDB's will be locked and considered “in doubt” until they are completed. If the server cannot be restarted in a timely fashion, and the transactions completed, then locks on the server applications and other resources may be held for a long time. This causes reliability problems within the e-commerce environment as a whole, and user frustration when trying to work with frozen applications.

### SUMMARY

In accordance with the present invention, the JMS server and MDB's are designed to be migratable from one application server to another. In order to expedite Message Driven Bean (MDB) recovery in a cluster environment before a failed server restarts, the MDB is implemented as a migratable service. This enables the migratable service framework to migrate the MDB and JMS server to another available server in the same cluster. After migration, MDB obtains ownership of the JMS server, and continues to pull the messages from the JMS server on behalf of the failed server. This allows the backup server to read the message from JMS server and continue the service.

MDB migration utilizes the migratable service framework for manual and automatic migration support, described in further detail in copending applications United States Provisional Patent Application entitled EXACTLY ONCE CACHE FRAMEWORK, Inventors Dean Bernard Jacobs and Eric M. Halpern, Application No. 60/317,718, filed Sep. 6, 2001, United States Utility Patent Application entitled EXACTLY ONCE CACHE FRAMEWORK, Inventors Dean Bernard Jacobs and Eric M. Halpern, Application No. 10/234,693, filed Sep. 4, 2002, United States Provisional Patent Application entitled EXACTLY ONCE JMS COMMUNICATION, Inventors Dean Bernard Jacobs and Eric M. Halpern, Application No. 60/317,566, filed Sep. 6, 2001, United States Utility Patent Application entitled EXACTLY ONCE JMS COMMUNICATION, Inventors Dean Bernard Jacobs and Eric M. Halpern, Application No. 10/234,597, filed Sep. 4, 2002, United States Provisional Patent Application entitled SYSTEM AND METHOD FOR MIGRATABLE SERVICES Inventor Eric M. Halpern, Application No. 60/358,418, filed Feb. 21, 2002, United States Utility Patent Application entitled SYSTEMS AND METHODS FOR MIGRATABLE SERVICES Inventor Eric M. Halpern, Application No. ______, filed Feb. 13, 2003, United States Provisional Patent Application entitled SYSTEM AND METHOD FOR AUTOMATED SERVICE MIGRATION Inventor Eric M. Halpern, Application No. 60/358,662, filed Feb. 21, 2002, and United States Utility Patent Application entitled SYSTEMS AND METHODS FOR AUTOMATED SERVICE MIGRATION Inventor Eric M. Halpern, Application No. ______, filed Feb. 13, 2003, all of which applications are incorporated herein by reference.

### BRIEF DESCRIPTION OF THE DRAWINGS

FIG. 1 shows a schematic illustration of a JMS server with MDB in accordance with an embodiment of the invention.

FIGS. 2A-2C show an illustration of a JMS/MDB server migration in accordance with an embodiment of the invention.

FIG. 3 shows a flowchart of a JMS/MDB server migration in accordance with an embodiment of the invention.

### DETAILED DESCRIPTION

The invention includes a mechanism for migrating MDB's from one application server to another. To help expedite Message Driven Bean (MDB) recovery in a cluster environment before a failed server restarts, the MDB is implemented as a migratable service. This enables the migratable service framework to migrate the MDB and JMS server to another available server in the same cluster. After the migration completes, MDB obtains ownership of the JMS server, and continues to pull the messages from the JMS server on behalf of the failed server. This allows the backup server to read the message from JMS server and continue the service.

In one embodiment MDB migration utilizes the migratable service framework for manual and automatic migration support, described in further detail in copending applications United States Provisional Patent Application entitled EXACTLY ONCE CACHE FRAMEWORK, Inventors Dean Bernard Jacobs and Eric M. Halpern, Application No. 60/317,718, filed Sep. 6, 2001, United States Utility Patent Application entitled EXACTLY ONCE CACHE FRAMEWORK, Inventors Dean Bernard Jacobs and Eric M. Halpern, Application No. 10/234,693, filed Sep. 4, 2002, United States Provisional Patent Application entitled EXACTLY ONCE JMS COMMUNICATION, Inventors Dean Bernard Jacobs and Eric M. Halpern, Application No. 60/317,566, filed Sep. 6, 2001, United States Utility Patent Application entitled EXACTLY ONCE JMS COMMUNICATION, Inventors Dean Bernard Jacobs and Eric M. Halpern, Application No. 10/234,597, filed Sep. 4, 2002, United States Provisional Patent Application entitled SYSTEM AND METHOD FOR MIGRATABLE SERVICES Inventor Eric M. Halpern, Application No. 60/358,418, filed Feb. 21, 2002, United States Utility Patent Application entitled SYSTEMS AND METHODS FOR MIGRATABLE SERVICES Inventor Eric M. Halpern, Application No. ______, filed Feb. 13, 2003, United States Provisional Patent Application entitled SYSTEM AND METHOD FOR AUTOMATED SERVICE MIGRATION Inventor Eric M. Halpern, Application No. 60/358,662, filed Feb. 21, 2002, and United States Utility Patent Application entitled SYSTEMS AND METHODS FOR AUTOMATED SERVICE MIGRATION Inventor Eric M. Halpern, Application No. ______, filed Feb. 13, 2003, all of which applications are incorporated herein by reference, although it will be evident that other types of framework can be used. System administrators can configure, manually migrate and monitor JMS server/MDB via either an Administration Console or a JMXAPI. Administrators can manually migrate the MDB along with JMS server of a failed server (i.e. the original server) to an available server in the same cluster. After the original server restarts, the administrator may manually migrate the MDB back to the original server.

There are two deployment schemes for specifying the JMS destination:

1. Simple destination. In this scheme, the EJB container keeps things simple by just deploying the MDB with the JMS destination when the JMS destination isn't distributed.

2. Distributed destination. In this scheme, the EJB container deploys an MDB with the JMS destination on every server when the JMS destination is distributed.

In accordance with the invention, the EJB container that is used for MDB accommodates these two schemes. Both the MDB and JMS destinations are deployed in the same server. If an application developer wants to spread the consumption load over the cluster, they can use a distributed destination and the system can co-deploy an MDB with every instance of the destination. Because that MDB can detect the migration target of the JMS server, there will be no migration target change for the MDB. An EJB module containing an MDB can continue to target at the current deployment targets. The MDB doesn't have to be separated from the EJB module. However, the MDB is required to be deployed within the cluster or on all of the servers on the JMS server migration targets list, because MDB deployment is not possible during the actual migration. In typical use, the MDB can be deployed with JMS destination on all servers in the migration target list, and remain inactive when the JMS destination is inactive.

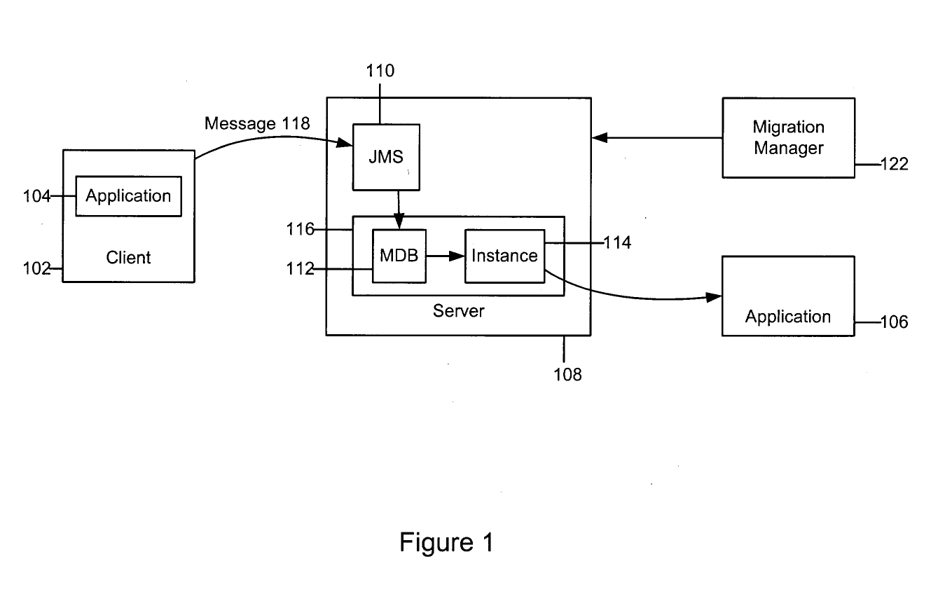

FIG. 1 illustrates a typical architecture in which a client interfaces with a server via a Message Driven Bean (MDB). As shown in FIG. 1, the application server 108 includes a JMS server 110 for receiving messages to be processed by the application server. Also included within the JMS server is a JMS queue 111 which holds JMS messages from the client application for processing by the message driven bean. The client 102, including the client application 104, generates JMS messages and sends them to the application server for placing on the JMS queue. This message holds the information necessary for the Message Driven Bean to operate. The MDB 112 is responsible for taking messages from the JMS queue and processing them. A Message Driven Bean may thus be considered a JMS message consumer. The client application cannot access the MDB directly, as they would when accessing session or entity beans. The client's only interface to the MDB is by sending messages to the JMS server and allowing the MDB to listen to those messages.

In practice the process for creating a MDB application is to set up an appropriate message queue in the JMS server, develop a client application that will be responsible for sending messages to this message queue, develop a MDB for retrieving these messages and processing them in accordance with the other server applications, developing deployment descriptors for the MDB, and finally, packaging the code and distributing it to a server. At application deployment time the developer must tell the container all of the information about the MDB contained within it. This is typically through the use of deployment descriptors. A common deployment descriptor file used in the java environment is the EJB-JAR file, although other deployment descriptor file types may be used in accordance with the invention. Deployment descriptor files that are not developed in accordance with the J2EE specification are commonly referred to as vendor-specific files. Some of the examples described below refer to WebLogic type description files, although it will be apparent to one of skill in the art that other deployment descriptor files may be used within the spirit and scope of the invention.

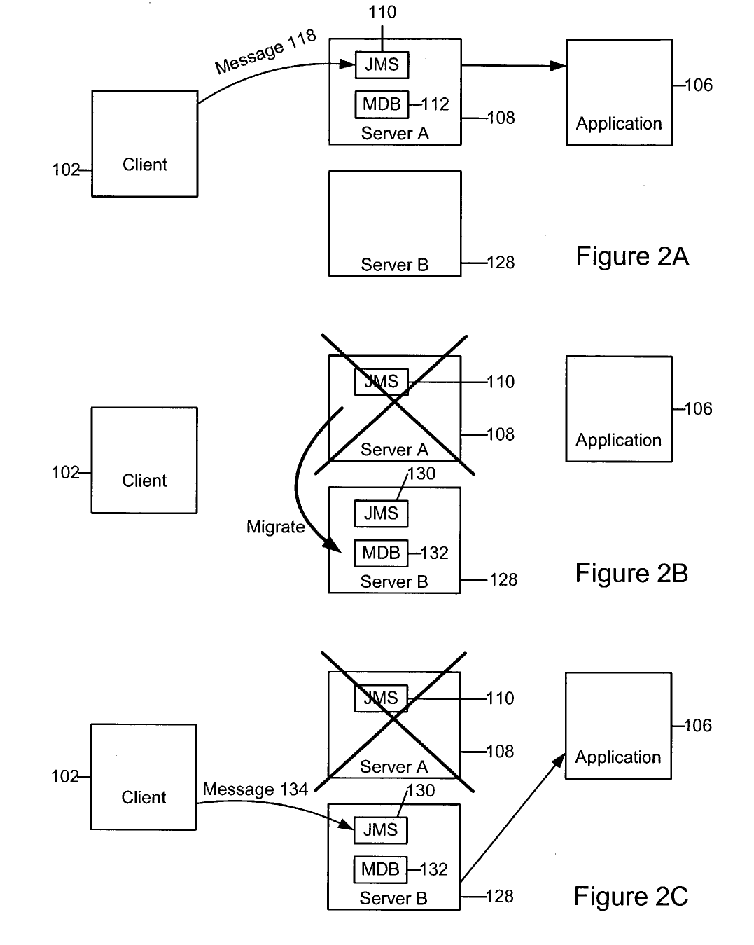

FIGS. 2A-2C show an illustration of a JMS/MDB server migration in accordance with an embodiment of the invention. As shown in FIG. 2A, the client 102 interacts with a server 108 and a server application 106 by means of passing messages 118 to the JMS server 110, which are then picked up by the message driven bean 112. If the MDB is registered as a migratable instance with the migration manager then, upon failure of server A, both the JMS and the MDB can be migrated to another server within the cluster 128. FIG. 2B illustrates a scenario in which server A has failed, or is deliberately shut down by an administrator (perhaps for administrative or maintenance purposes). Under normal circumstances the client's connection to the JMS/MDB server would be broken and hence they would not be able to access the application 106. However, in accordance with the invention the JMS server and it's associated MDB 132 is migrated from server A to server B. As shown in FIG. 2C, this allows the client 102 to access the application 106 via the new server B 128, while messages to the JMS server 130 are handled by the new MDB 132.

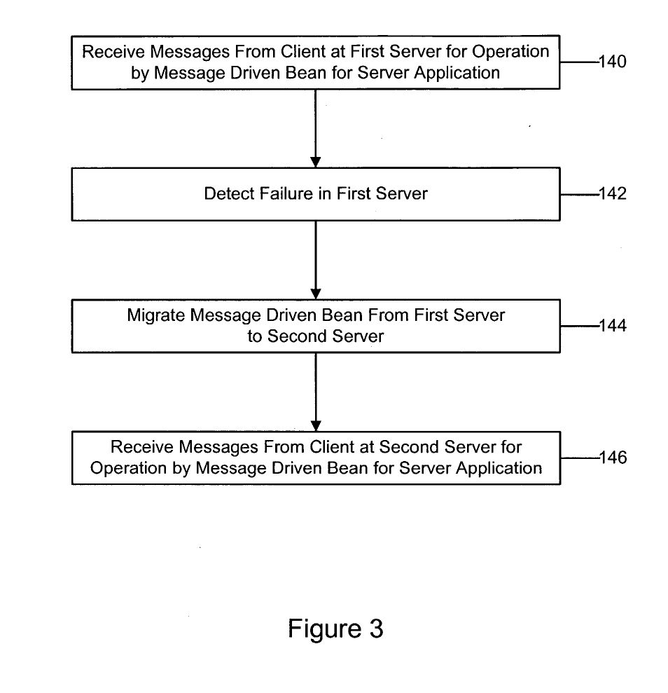

FIG. 3 shows a flowchart of a JMS/MDB server migration in accordance with an embodiment of the invention. As shown in FIG. 3, the first step in the process, step 140, is to receive messages from the client application at a first server for operation by a message driven bean at that server. Upon detecting a failure or a command to shut down the first server, in step 142, the Message Driven Bean is migrated as a service from the first server to the second server (step 144). The actual method of migrating the service from one server to another server within a cluster is described in further detail in co-pending applications United States Provisional Patent Application entitled EXACTLY ONCE CACHE FRAMEWORK, Inventors Dean Bernard Jacobs and Eric M. Halpern, Application No. 60/317,718, filed Sep. 6, 2001, United States Utility Patent Application entitled EXACTLY ONCE CACHE FRAMEWORK, Inventors Dean Bernard Jacobs and Eric M. Halpern, Application No. 10/234,693, filed Sep. 4, 2002, United States Provisional Patent Application entitled EXACTLY ONCE JMS COMMUNICATION, Inventors Dean Bernard Jacobs and Eric M. Halpern, Application No. 60/317,566, filed Sep. 6, 2001, United States Utility Patent Application entitled EXACTLY ONCE JMS COMMUNICATION, Inventors Dean Bernard Jacobs and Eric M. Halpern, Application No. 10/234,597, filed Sep. 4, 2002, United States Provisional Patent Application entitled SYSTEM AND METHOD FOR MIGRATABLE SERVICES Inventor Eric M. Halpern, Application No. 60/358,418, filed Feb. 21, 2002, United States Utility Patent Application entitled SYSTEMS AND METHODS FOR MIGRATABLE SERVICES Inventor Eric M. Halpern, Application No. ______, filed Feb. 13, 2003, United States Provisional Patent Application entitled SYSTEM AND METHOD FOR AUTOMATED SERVICE MIGRATION Inventor Eric M. Halpern, Application No. 60/358,662, filed Feb. 21, 2002, and United States Utility Patent Application entitled SYSTEMS AND METHODS FOR AUTOMATED SERVICE MIGRATION Inventor Eric M. Halpern, Application No. ______, filed Feb. 13, 2003, all of which applications are incorporated herein by reference. In step 146, the migrated JMS server and associated MDB receives messages from the client at the second server, for operation by the Message Driven Bean upon the server application.

### Implementation Example

A typical implementation that uses the invention is described in further detail below. It will be evident to one skilled in the art that some of the features described below are general to all object based systems, while others are specific to certain application servers. It will be further evident to one skilled in the art that the principles described below are generally applicable to other application server environments. In a WebLogic environment, the MDB implements the weblogic.cluster.Migratable interface. This allows the MDB to respond to activate and deactivate requests from the migration manager.

### Initialization

Initialization of a MDB includes processing any configuration or deployment information and creating the appropriate objects.

### Activation

When an MDB is activated, it detects the JMS server associated with it, and starts pulling the messages from the JMS destination.

### Deactivation

When an MDB is deactivated it stops all message pulling and processing, finishes all of the current transactions, and delete all MDB objects.

### Register/Un-register the Migratable MDB

In the migration framework, a migratable instance must register with weblogic.cluster.MigrationManager. An MDB can have multiple instances to serve the messages on the destination, and it is unpractical to register every instance of the MDB with the MigrationManager. A wrapper is then created to do the following:

1. Register/un-register the migratable instance with the weblogic. cluster.MigrationManager

2. Create, pool, and destroy all the MDB instances.

### Detect JMS Server Destination

The MDB can detect the JMS migration target by using the module descriptors inside the EJB module. This reduces the configuration complexity. In one implementation, the MDB can detect the JMS migration target by following the path:

MDB name→JNDI name→find destination of same JNDI name →find JMSServer of destination

to find migratable target the JMS is deployed to.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, it will be evident that while the examples described herein illustrate how the invention may be used in a WebLogic environment, other application server environments may use and benefit from the invention. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for migrating message driven bean services in an application server environment, comprising:
a first application server for receiving messages from a client application for operation by a message driven bean at that server;
a failover mechanism for shutting down said first application server;
a migratable message driven bean service that can be migrated from said first application server to a second application server; and,
wherein a signal from the failover mechanism to shut down said first application server causes said migratable message driven bean service to receive messages from the client at said second application server, for operation by said migrated message driven bean.

2. The system of claim 1 wherein said message driven bean can be registered as a migratable message driven bean to allow it to participate in the migration process.

3. The system of claim 1 wherein said first application server and said second application servers are Java-based application servers.

4. The system of claim 1 wherein said first application server and said second application server are members of a plurality of application servers in a clustered environment.

5. The system of claim 1 wherein said failover mechanism is initiated automatically upon detecting a failure in said first application server.

6. The system of claim 1 wherein said failover mechanism can be initiated manually by a user or administrator.

7. The system of claim 1 wherein said first application server includes a JMS server, which upon migration of said message driven bean service is also migrated to said second application server.

8. A method for migrating message driven beans services in a Java server environment, comprising the steps of:
receiving messages from a client application at a first application server for operation by a message driven bean at that server;
detecting a failure within said first application server or a command to shut down said first application server;
migrating said message driven bean as a service from said first application server to a second application server; and,
receiving messages from the client at said second application server, for operation by said migrated message driven bean.

9. The method of claim 8 wherein said message driven bean can be registered as a migratable message driven bean to allow it to participate in the migration process.

10. The method of claim 8 wherein said first application server and said second application servers are Java-based application servers.

11. The method of claim 8 wherein said first application server and said second application server are members of a plurality of application servers in a clustered environment.

12. The method of claim 8 wherein said step of migrating upon failure is initiated automatically upon detecting a failure in said first application server.

13. The method of claim 8 wherein said step of migrating upon failure can be initiated manually by a user or administrator.

14. The method of claim 8 wherein said first application server includes a JMS server, which upon migration of said message driven bean service is also migrated to said second application server.
